(19) United States
(12) Patent Application Publication
(10) Pub. No.: US 2025/0225770 A1
(43) Pub. Date: Jul. 10, 2025

(54) AUTONOMOUS ENRICHING REFERENCE INFORMATION

(71) Applicant: AI QUALISENSE 2021 LTD, Tel Aviv-Yafo (IL)

(72) Inventors: Tom TABAK, Tel Aviv (IL); Zvi Lapp, Modi'in Maccabim-Re'ut (IL)

(73) Assignee: AI QUALISENSE 2021 LTD, Tel Aviv-Yafo (IL)

(21) Appl. No.: 18/854,949

(22) PCT Filed: Apr. 5, 2023
(86) PCT No.: PCT/IB2023/053464

§ 371 Date: Oct. 7, 2024

Related U.S. Application Data
(60) Provisional application No. 63/362,522, filed on Apr. 5, 2022.

(51) Int. Cl. G06V 10/771; G06V 10/72; G06V 10/74; G06V 10/82

(52) U.S. Cl. CPC G06V 10/771; G06V 10/72; G06V 10/761; G06V 10/82

(57) ABSTRACT

A method for autonomous enriching reference information, including (a) obtaining a current group of trusted reference images of non-anomalous instances of an item: (b) calculating reference pixel-wise distribution information: (c) obtaining multiple sets of item instance pixels from current acquired images of instances of the item, each set originated from an image of an instance of the item and comprises multiple item instance pixels: (d) determining item features of the item for each set, based on the multiple item pixels of the set and by a non-item specific neural network: (e) determining a pixel score for item pixels of the multiple item pixels: (f) calculating a distance between the pixel score and the reference pixel-wise distribution information; and (g) selecting at least one current acquired image to add to the trusted reference images, based on at least one distance of at least one pixel per current acquired image.

### BACKGROUND

Defect detection is a process that involve acquiring images of evaluated objects and processing the images to detect defects. A common method for defect detection include comparing an image of an evaluated object to an image of a reference object.

It may be beneficial to compare the evaluated object to a reference object that is defect free—but generating an image of a defect free reference object may also be time and resource consuming. Comparing the inspected object to an arbitrary reference object may provide ambiguous results—as a different between the evaluated object and the reference object may result from defects of the evaluated object or the reference object.

There is a growing need to provide a cost-effective method for cluster-based and autonomous finding of reference information.

### SUMMARY

There is provided a method, a system and/or a non-transitory computer readable medium for autonomous enriching reference information.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a method;

FIG. 3 illustrates an example of a method;

FIG. 4 is an example of images and data structures; and

FIG. 5 is an example of a system.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of the units may be implemented in hardware and/or code, instructions and/or commands stored in a non-transitory computer readable medium, may be included in a vehicle, outside a vehicle, in a mobile device, in a server, and the like.

The vehicle may be any type of vehicle that a ground transportation vehicle, an airborne vehicle, and a water vessel.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors-such as a visual light camera, an audio sensor, a sensor that may sense infrared, radar imagery, ultrasound, electro-optics, radiography, LIDAR (light detection and ranging), unidimensional data (current, voltage, pressure) etc. The sensing may include generating samples (for example, pixel, audio signals) that represent the signal that was transmitted, or otherwise reach the sensor.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There may be provide a method, system and a non-transitory computer readable medium for autonomous enriching reference information.

The method, system and a non-transitory computer readable medium can process any amount of images of instances of an item-without needing to tag the images.

There may be any number of instances of the item. If the item is, for example, an object then the different instances may include different objects that should (if manufactured under ideal defect-free conditions) be the same.

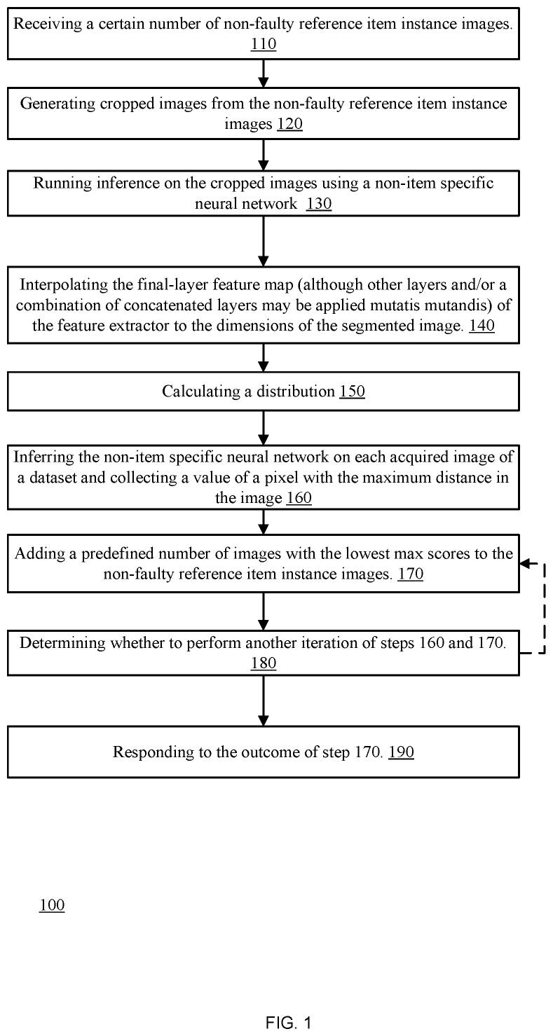

FIG. 1 illustrates an example of method 100 for autonomous enriching reference information.

Method 100 may start by step 110 of receiving (for example—from a human in the loop) a certain number (for example 5-20) of non-faulty reference item instance images.

Step 110 may be followed by step 120 of generating cropped images from the non-faulty reference item instance images.

Step 120 may be followed by step 130 of running inference on the cropped images using a non-item specific neural network—for example a generic, industry standard state-of-the-art pre-trained neural network (such but not limited to wide ResNet50 pretrained on ImageNet, though other architectures and/or training datasets may be applied mutatis mutandis). The non-item specific neural network may be a feature extractor.

Step 130 may be followed by step 140 of interpolating the final-layer feature map (although other layers and/or a combination of concatenated layers may be applied mutatis mutandis) of the feature extractor to the dimensions of the segmented image. The interpolating may “match” the dimensions of the final layer feature map to the dimensions of the segments image. Various interpolations may be used—for example a Bi-linear interpolation.

Step 140 may be followed by step 150 of calculating, per each of the non-faulty reference item instance images, a pixel wise mean value of the feature map for every pixel i, j as well as a covariance matrix-which together shall here on forth be referred to as the distribution.

Step 150 may be followed by step 160 of inferring the non-item specific neural network on each acquired image of a dataset (the dataset may include images other than the non-faulty reference item instance images) and collecting a value (denoted max_score) of a pixel with the maximum distance (from the distribution) in the image. Any distance may be used—for example Mahalanobis distance. The collected value may differ from the maximal value—for example may be the y′th highest value, whereas y may differ from 1, may range between 2 to 10 or 20, and the like.

Step 160 may be followed by step 170 of adding a predefined number (or a predefined portion of the images to be mined—for example up to 20%, 25%, 30%, 35%, and the like) of images with the lowest max scores to the non-faulty reference item instance images.

Step 170 may be followed by step 180 of determining whether to perform another iteration of steps 160 and 170—for example checking whether the non-faulty reference item instance images (after the adding of step 170) reaches a predefined threshold.

After a completion of the required repetitions-step 180 may be followed by step 190 of responding to the outcome of step 170.

Step 190 may include calculating the distance between the final decided upon centroids and every non-centroid image. The number of X (value of X may be determined in any manner) images with the highest distance can also be believed to be faulty.

Step 190 may include storing the non-faulty reference item instance images (after the adding of step 170), transmitting the non-faulty reference item instance images (after the adding of step 170), using the non-faulty reference item instance images (after the adding of step 170) in future inspection processes, and the like.

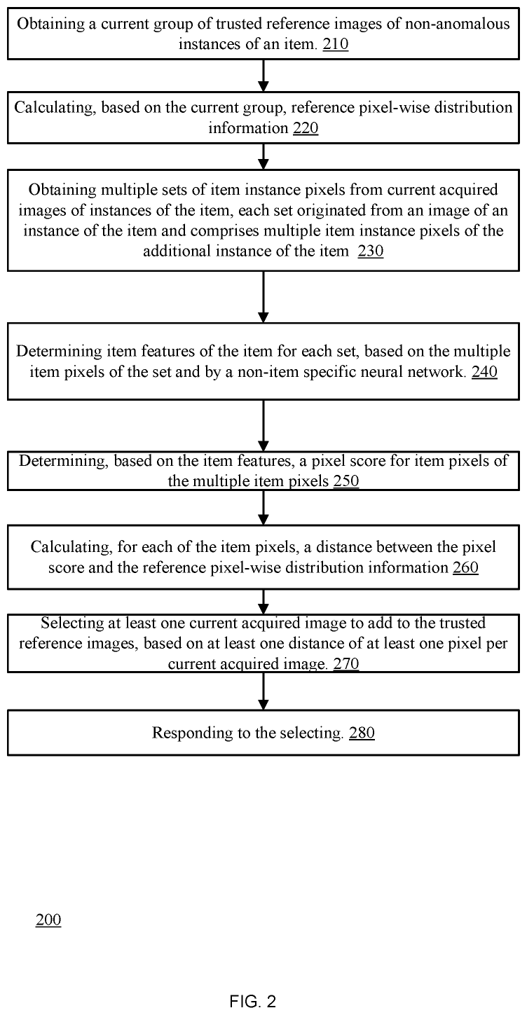

FIG. 2 illustrates method 200 for autonomous enriching reference information.

Method 200 may start by step 210 of obtaining a current group of trusted reference images of non-anomalous instances of an item.

Step 210 may be followed by step 220 of calculating, based on the current group, reference pixel-wise distribution information.

Step 220 may be followed by multiple repetitions of steps 230-280. Steps 210-220 may repeated multiple times.

Step 230 may include obtaining multiple sets of item instance pixels from current acquired images of instances of the item, each set originated from an image of an instance of the item and comprises multiple item instance pixels of the additional instance of the item.

Step 230 may include obtaining of the multiple item pixels by receiving an image and generating a cropped image that comprises the multiple item pixels.

Step 230 may be followed by step 240 of determining item features of the item for each set, based on the multiple item pixels of the set and by a non-item specific neural network.

The non-item specific neural network may be pre-trained to perform feature extraction of objects, at least some of the objects differ from the item.

Step 240 may be followed by step 250 of determining, based on the item features, a pixel score for item pixels of the multiple item pixels.

Step 250 may be followed by step 260 of calculating, for each of the item pixels, a distance between the pixel score and the reference pixel-wise distribution information.

The reference pixel-wise distribution information may include a reference mean matrix and reference covariance matrix.

The group covariance information may be a covariance matrix and the mean value information is a group mean value matrix.

Step 260 may be followed by step 270 of selecting at least one current acquired image to add to the trusted reference images, based on at least one distance of at least one pixel per current acquired image.

Step 270 may be based on a maximal distance per current acquired image.

Step 270 may include searching for up to a predefined number of current acquired images of lowest maximal distance. The predefined number does not exceed a number of current group of trusted reference images of a first iteration.

Step 270 may be followed by step 280 of responding to the selecting. The responding may include storing the one or more images of non-anomalous items, storing the one or more selected clusters, using the selected one or more images during an inspection or an evaluation process, and the like

Steps 230-270 may be repeated multiple times until reaching a predefined overall number of trusted reference images.

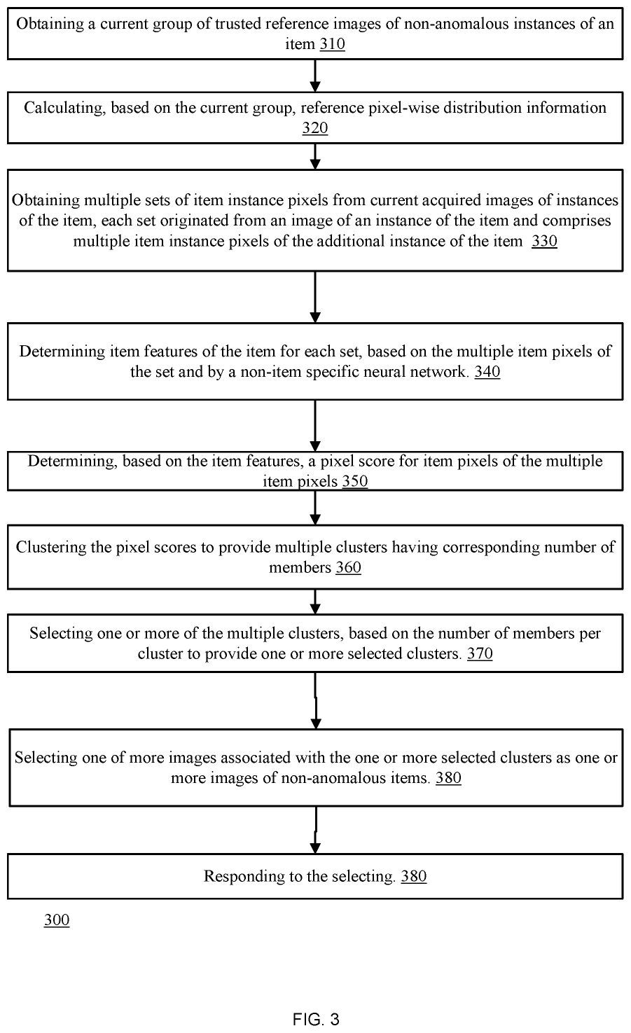

FIG. 3 illustrates method 300 for autonomous enriching reference information.

Method 300 may start by step 310 of obtaining a current group of trusted reference images of non-anomalous instances of an item.

Step 310 may be followed by step 320 of calculating, based on the current group, reference pixel-wise distribution information.

Step 320 may be followed by multiple repetitions of steps 330-390. Steps 310-320 may repeated multiple times.

Step 330 may include obtaining multiple sets of item instance pixels from current acquired images of instances of the item, each set originated from an image of an instance of the item and comprises multiple item instance pixels of the additional instance of the item.

Step 330 may be followed by step 340 of determining item features of the item for each set, based on the multiple item pixels of the set and by a non-item specific neural network.

Step 340 may be followed by step 350 of determining, based on the item features, a pixel score for item pixels of the multiple item pixels.

Step 350 may be followed by step 360 of clustering the pixel scores to provide multiple clusters having corresponding number of members.

Step 360 may be followed by step 370 of selecting one or more of the multiple clusters, based on the number of members per cluster to provide one or more selected clusters.

Step 370 may be followed by step 380 of selecting one of more images associated with the one or more selected clusters as one or more images of non-anomalous items.

Step 380 may be followed by step 390 of responding to the selecting. The responding may include storing the one or more images of non-anomalous items, storing the one or more selected clusters, using the selected one or more images during an inspection or an evaluation process, and the like.

Step 380 may include selecting one of more clusters with a highest number of members. For example—the X′th clusters having the X′th highest number of members. The value of X may be determined in any manner.

The mentioned above methods provide highly accurate and effective (in terms of computational and/or storage resource utilizations.

For example—when applying the methods using an iterative process of adding only a relative small number (for example—in the range of 10-100, 50-300 and the like) of images to the trusted reference images bank-allows to gradually expand the variability of the accepted reference images rather that adding more images at a time (and hence variability) which could be detrimental to the accuracy of the distribution building. Hence, the methods enable a gradual build of the distribution in a controlled way that manifests its accuracy superiority.

Furthermore—the mentioned above methods managed to reduce the false alarm rate (percentage of not good images being erroneously accepted as trusted reference images) from around 40% (achieved by a single non-iterative approach) to 0% (achieved by the iterative method we are currently discussing).

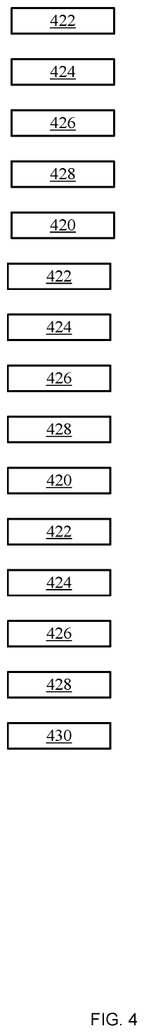

FIG. 4 is an example of images and data structures such as non-faulty reference item instance images 402, cropped images 404, feature map 406 (of final layer or another layer), acquired images 408 of a dataset, distribution 410, predefined number of images with the lowest max scores 412, current group of trusted reference images of non-anomalous instances of an item 414, reference pixel-wise distribution information 416, sets (418) of item instance pixels from current acquired images of instances of the item, item features 420, pixel score 422, selected at least one current acquired image 424, clusters 426, selected one or more clusters 428, one or more images of non-anomalous items 430.

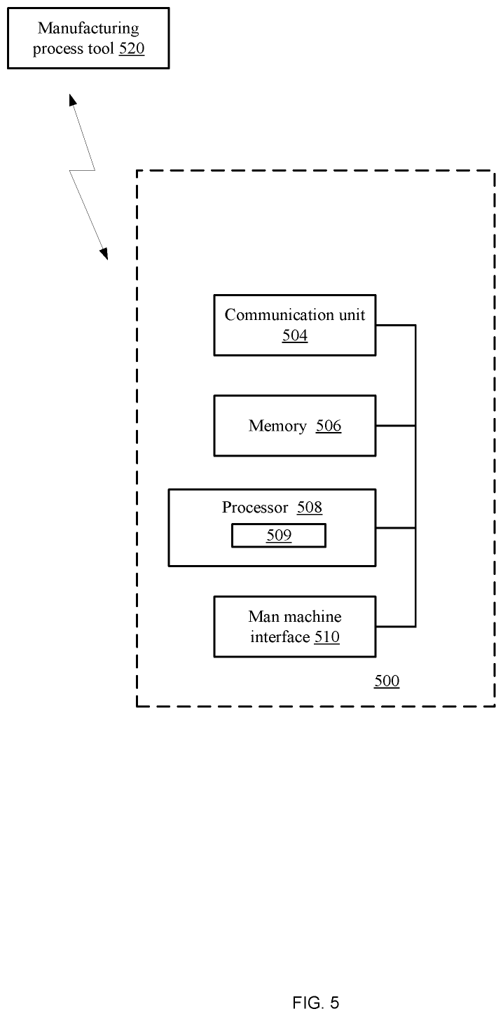

FIG. 5 illustrates an example of a computerized system 500 and a manufacturing process tool 520.

The computerized system 500 may execute method 100 and/or method 200 and/or method 300.

The computerized system 500 may or may not communicate with the manufacturing process tool 520—for example to provide feedback about the manufacturing process applied by the manufacturing process tool 520 (that manufactured the evaluated manufactured items) and/or for receiving images of the evaluated manufactured items, and the like. The computerized system 500 may be included in the manufacturing process tool 520.

The computerized system 500 may include a communication unit 504, memory 506, processor 508 and may optionally include a man machine interface 510. The processor 508 may implement a neural network such as but not limited to a non-item specific neural network 509.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A method for autonomous enriching reference information, the method comprises:
(a) obtaining a current group of trusted reference images of non-anomalous instances of an item;
(b) calculating, based on the current group, reference pixel-wise distribution information;
(c) obtaining multiple sets of item instance pixels from current acquired images of instances of the item, each set originated from an image of an instance of the item and comprises multiple item instance pixels of the additional instance of the item;
(d) determining item features of the item for each set, based on the multiple item pixels of the set and by a non-item specific neural network;
(e) determining, based on the item features, a pixel score for item pixels of the multiple item pixels;
(f) for each of the item pixels, calculating a distance between the pixel score and the reference pixel-wise distribution information; and
(g) selecting at least one current acquired image to add to the trusted reference images, based on at least one distance of at least one pixel per current acquired image.

2. The method according to claim 1 wherein the selecting is based on a maximal distance per current acquired image.

3. The method according to claim 2 wherein the selecting comprises searching for up to a predefined number of current acquired images of lowest maximal distance

4. The method according to claim 3 wherein the predefined number does not exceed a number of current group of trusted reference images of a first iteration.

4. The method according to claim 1 comprising performing multiple iterations of steps (a)-(g) until reaching a predefined overall number of trusted reference images.

5. The method according to claim 1 comprising obtaining of the multiple item pixels comprises receiving an image and generating a cropped image that comprises the multiple item pixels.

6. The method according to claim 1 wherein the reference pixel-wise distribution information belongs is a part of reference information that comprises a reference mean matrix and reference covariance matrix.

7. The method according to claim 6 wherein the group covariance information is a covariance matrix and the mean value information is a group mean value matrix.

8. The method according to claim 1 wherein the non-item specific neural network is pre-trained to perform feature extraction of objects, at least some of the objects differ from the item.

9. A non-transitory computer readable medium for autonomous enriching reference information, the non-transitory computer readable medium that stores instructions for
(a) obtaining a current group of trusted reference images of non-anomalous instances of an item;
(b) calculating, based on the current group, reference pixel-wise distribution information;
(c) obtaining multiple sets of item instance pixels from current acquired images of instances of the item, each set originated from an image of an instance of the item and comprises multiple item instance pixels of the additional instance of the item;
(d) determining item features of the item for each set, based on the multiple item pixels of the set and by a non-item specific neural network;
(e) determining, based on the item features, a pixel score for item pixels of the multiple item pixels;
(f) for each of the item pixels, calculating a distance between the pixel score and the reference pixel-wise distribution information; and
(g) selecting at least one current acquired image to add to the trusted reference images, based on at least one distance of at least one pixel per current acquired image.

10. The non-transitory computer readable medium according to claim 9 wherein the selecting is based on a maximal distance per current acquired image.

11. The non-transitory computer readable medium according to claim 10 wherein the selecting comprises searching for up to a predefined number of current acquired images of lowest maximal distance

12. The non-transitory computer readable medium according to claim 11 wherein the predefined number does not exceed a number of current group of trusted reference images of a first iteration.

13. The non-transitory computer readable medium according to claim 9 that stores instructions for performing multiple iterations of steps (a)-(g) until reaching a predefined overall number of trusted reference images.

14. The non-transitory computer readable medium according to claim 9 that stores instructions for obtaining of the multiple item pixels comprises receiving an image and generating a cropped image that comprises the multiple item pixels.

15. The non-transitory computer readable medium according to claim 9 wherein the reference pixel-wise distribution information belongs is a part of reference information that comprises a reference mean matrix and reference covariance matrix.

16. The non-transitory computer readable medium according to claim 15 wherein the group covariance information is a covariance matrix and the mean value information is a group mean value matrix.

17. The non-transitory computer readable medium according to claim 9 wherein the non-item specific neural network is pre-trained to perform feature extraction of objects, at least some of the objects differ from the item.

18. A method for autonomous enriching reference information, the method comprises:
(a) obtaining a current group of trusted reference images of non-anomalous instances of an item;
(b) calculating, based on the current group, reference pixel-wise distribution information;
(c) obtaining multiple sets of item instance pixels from current acquired images of instances of the item, each set originated from an image of an instance of the item and comprises multiple item instance pixels of the additional instance of the item;
(d) determining item features of the item for each set, based on the multiple item pixels of the set and by a non-item specific neural network;
(e) determining, based on the item features, a pixel score for item pixels of the multiple item pixels;
(f) clustering the pixel scores to provide multiple clusters having corresponding number of members;
(g) selecting one or more of the multiple clusters, based on the number of members per cluster to provide one or more selected clusters; and
(h) selecting one of more images associated with the one or more selected clusters as one or more images of non-anomalous items.

19. The method according to claim 18 wherein the selecting comprises selecting one of more clusters with a highest number of members.
